(19) United States
(12) Patent Application Publication
(10) Pub. No.: US 2010/0202468 A1
(43) Pub. Date: Aug. 12, 2010

(54) BRIDGE, DATA COMPRESSING METHOD THEREOF AND COMPUTER SYSTEM APPLYING THE SAME

(75) Inventor: Ming-Cheng Chang, Hsinchu City (TW)

Correspondence Address: RABIN & Berdo, PC, 1101 14TH STREET, NW, SUITE 500, WASHINGTON, DC, 20005, US

(73) Assignee: Prolific Technology Inc., Taipei (TW)

(21) Appl. No.: 12/635,007

(22) Filed: Dec. 10, 2009

(30) Foreign Application Priority Data
Feb. 9, 2009 (TW) 098104083

(51) Int. Cl. H04L 12/56

(52) U.S. Cl. 370/401

(57) ABSTRACT

Provided is a bridge coupled between an external host and an external storage device. The bridge includes a first interface, an encoder, a memory device, a decoder and a second interface. The first interface is coupled to the external host and receives a first data from an external host. The encoder is coupled to the first interface and compresses the first data by undistorted compression for producing a second data. The memory device is coupled to the encoder and temporally stores the second data produced by the encoder. The decoder is coupled to the memory device and decompresses the second data stored in the memory device for producing a third data. The third data and the first data are substantially the same. The second interface is coupled between the decoder and the external storage device and outputs the third data transmitted from the decoder to the external storage device.

This application claims the benefit of Taiwan application Serial No. 98104083, filed Feb. 9, 2009, the subject matter of which is incorporated herein by reference.

### BACKGROUND

1. Field

The invention relates in general to a bridge and a data compressing method thereof, and more particularly to a bridge with undistorted compression function and a data compressing method thereof.

2. Description of the Related Art

Living in the modern society where science and technology have gained rapid advance, computer has become an indispensible electronic product to modern people. Data is transmitted between a computer and an external storage device through a bridge.

However, when the external storage device transmits data to an internal storage device of a computer through a bridge, the transmission rates at the two terminals (that is, the external storage device and the computer) may match with each other or poles apart. When the transmission rates at the two terminals match with each other, the capacity of the internal buffer memory of the bridge does not affect the transmission performance much.

When the transmission rates at the two terminals are poles apart and one terminal (for example, the external storage device) needs long preparation time, the capacity of the internal buffer memory of the bridge will have great impact on the transmission performance. As one terminal needs a long period of preparation time, the transmission rate is decreased. Despite increasing the capacity of the internal buffer memory of the bridge helps to increase the transmission rate, the cost for the bridge increases significantly.

Thus, how to increase the transmission rate without largely increasing the cost has become an imminent issue to be resolved.

### SUMMARY

Examples of the invention are directed to a bridge, a data compressing method thereof and a computer system applying the same. According to examples of the invention, data temporarily stored in the bridge are compressed by way of undistorted compression, so that transmission rate is increased without increasing the capacity of the internal memory of the bridge. The increased cost is not much.

According to an example of the present invention, a bridge coupled between an external host and an external storage device is provided. The bridge includes a first interface, an encoder, a memory device, a decoder and a second interface. The first interface coupled to the external host receives a first data from an external host. The encoder coupled to the first interface compresses the first data by undistorted compression for producing a second data. The memory device coupled to the encoder temporally stores the second data produced by the encoder. The decoder coupled to the memory device decompresses the second data stored in the memory device for producing a third data. The third data and the first data are substantially the same. The second interface coupled between the decoder and the external storage device outputs the third data transmitted from the decoder to the external storage device.

According to another example of the present invention, a data compressing method used in a bridge is provided. The data compressing method includes following steps. Firstly, a first data is received. Next, the first data is compressed by undistorted compression for producing a second data. Then, the second data is temporarily stored. Afterwards, the second data temporarily stored is decompressed for producing a third data. Lastly, the third data is provided.

According to still another example of the present invention, a computer system including an external host, an external storage device and a bridge is provided. The bridge is coupled between the external host and the external storage device. The bridge receives a first data from the external host. The first data is compressed by undistorted compression for producing a second data. The bridge temporarily stores the second data and further decompresses the second data being temporarily stored for producing a third data, wherein the third data and the first data are substantially the same. The bridge outputs the third data to the external storage device.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a bridge according to an embodiment of the invention;

FIG. 2A shows waiting in the prior art;

FIG. 2B shows waiting according to the embodiment of the invention; and

FIG. 3 shows a flowchart of a data compressing method in a bridge according to the embodiment of the invention.

### DETAILED DESCRIPTION OF EXEMPLARY EMBODIMENT OF THE INVENTION

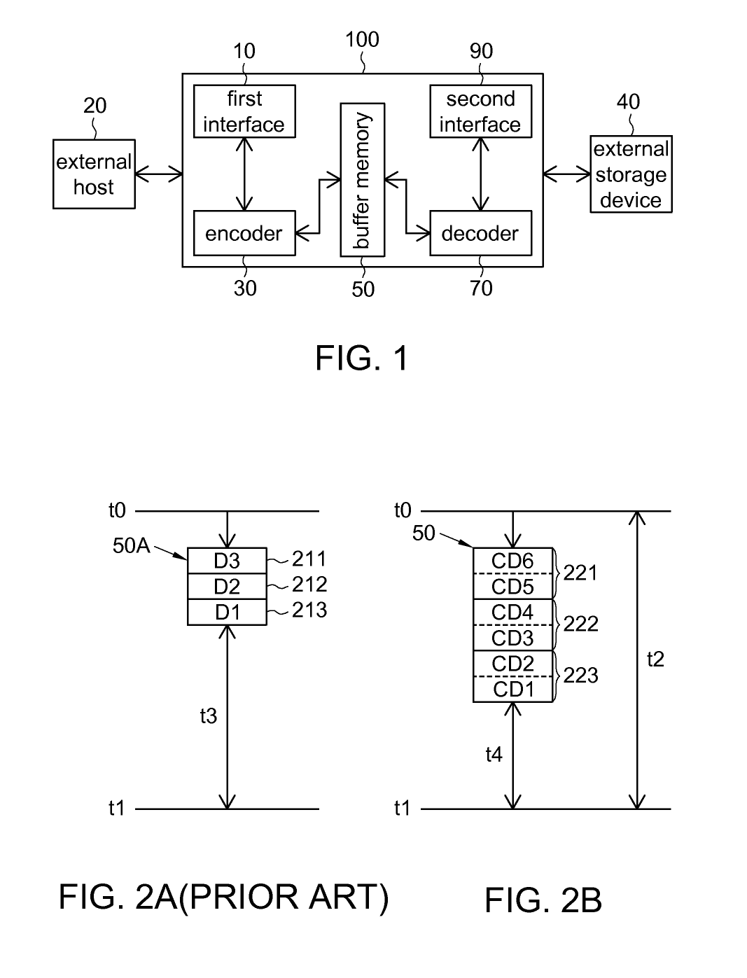

Referring to FIG. 1, a bridge according to an embodiment of the invention is shown. As indicated in FIG. 1, a computer system includes an external host 20, an external storage device 40 and a bridge 100. The bridge 100 is coupled between the external host 20 and the storage device 40. The bridge 100 at least includes a first interface 10, an encoder 30, a buffer memory 50, a decoder 70 and a second interface 90. The external host 20 can be but not limited to a personal computer (PC) or a notebook computer (NB).

The first interface 10 receives data from the external host 20. That is, the bridge 100 can be linked to the external host 20 through the first interface 10. Also, the first interface 10 is at least one of a universal serial bus (USB), a serial advanced technology attachment (SATA) and a personal computer interface (PCI) or any combination thereof.

The encoder 30 compresses data transmitted from the external host 20. The encoder 30 receives data transmitted from the external host 20 through the first interface 10. The encoder 30 compresses data by way of undistorted compression, which is not specified here. In the present embodiment of the invention, “undistorted compression” refers to decompressed data being substantially the same with original data, so that completeness and accuracy of data are maintained.

The buffer memory 50 temporally stores the compressed data transmitted from the encoder 30. When the external host 20 transmits data to the storage device 40 through the bridge 100, the storage device 40 needs a period of preparation time to be ready. During the period of preparation time, the storage device 40 is unable to receive data transmitted from the external host 20, but data transmitted from the external host 20 during this period of time is still compressed by the encoder 30 and stored in the buffer memory 50. Once the storage device 40 is ready, data stored in the buffer memory 50 is transmitted to the storage device 40. However, when the buffer memory 50 reaches the limit of its capacity (i.e. full), the external host 20 stops transmitting data, and the transmission of data will be resumed once the buffer memory 50 has space for writing data (i.e. not full).

The decoder 70 decompresses the data which is undistorted compressed by the encoder 30. The decoder 70 obtains the compressed data from the buffer memory 50, and further decompresses the compressed data to obtain a decompressed data. Despite data are compressed by the encoder 30 and then decompressed by the decoder 70, the decompressed data is substantially the same with the original data transmitted from the external host 20.

The second interface 90 outputs the decompressed data to the storage device 40. The bridge 100 is linked to the storage device 40 through the second interface 90. The storage device 40 can be but not limited to at least one of a flash memory, an optical disc driver (ODD), and a hard disc driver (HDD) or any combination thereof.

Referring to FIG. 2A and FIG. 2B, waiting in prior art and according to the embodiment of the invention are respectively shown. In FIG. 2A and FIG. 2B, t0 denotes the time point when the external host 20 starts to transmit data, and t1 denotes the time point when the storage device starts to receive data. The time difference t2 between t0 and t1 denotes the preparation time for the storage device 40 to be ready.

In FIG. 2A, the internal buffer memory 50A of a conventional bridge includes three memory units 211, 212 and 213. In FIG. 2B, the buffer memory 50 according to the embodiment of the invention includes three memory units 221, 222 and 223 for example, but the invention is not limited thereto. The capacity of the memory units 211˜213 is the same with that of the memory units 221˜223.

As the conventional bridge does not apply undistorted compression to the received data, the memory units 211˜213 stores three data D1˜D3 transmitted from the external host 20.

In the present embodiment of the invention, the encoder 30 compresses six data D1˜D6 transmitted from the external host 20 into compressed data CD1˜CD6 by way of undistorted compression with 50% of compression ratio. The compressed data CD1˜CD6 are stored to the memory units 221˜223. For simplicity, it is assumed that each of data D1˜D6 is of the same size. As the buffer memory 50 can store more data amount without increasing its capacity, the waiting time t4 of the present embodiment of the invention is shorter than the waiting time t3 of prior art, hence increasing data transmission rate.

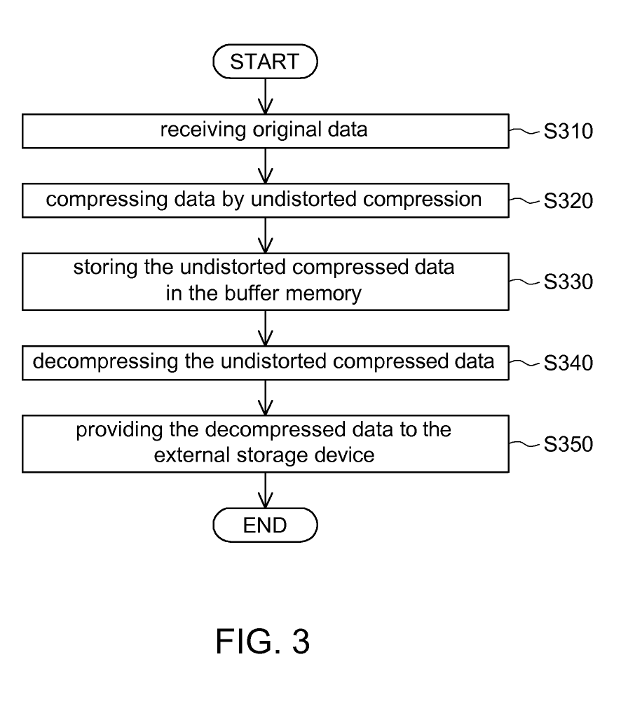

The operation procedures of the bridge 100 of the present embodiment of the invention are disclosed below. Referring to FIG. 3, a flowchart of a data compressing method in the bridge according to the embodiment of the invention is shown. Firstly, the method begins at step S310 in which the first interface 10 receives an original data transmitted from the external host 20 for example.

Next, the method proceeds to step S320 in which the original data is compressed by the encoder 30 by way of undistorted compression.

Then, the method proceeds to step S330 in which the undistorted compressed data is stored in the buffer memory 50.

Afterwards, the method proceeds to step S340 in which the undistorted compressed data stored in the buffer memory 50 is decompressed by the decoder 70.

Lastly, the method proceeds to step S350 in which the decompressed data is provided to the storage device through the second interface 90.

The bridge of the present embodiment of the invention has advantages of compressing data and storing more data without increasing the capacity of the buffer memory. Thus, the transmission efficiency is effectively increased without increasing too much cost.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A bridge coupled between an external host and an external storage device, comprising:
a first interface coupled to the external host for receiving a first data transmitted from the external host;
an encoder coupled to the first interface for compressing the first data by undistorted compression for producing a second data;
a memory device coupled to the encoder for temporally storing the second data produced by the encoder;
a decoder coupled to the memory device for decompressing the second data stored in the memory device for producing a third data, wherein the third data and the first data are substantially the same; and
a second interface coupled between the decoder and the external storage device for outputting the third data transmitted from the decoder to the external storage device.

2. The bridge according to claim 1, wherein the first interface comprises at least one of a universal serial bus (USB), a serial advanced technology attachment (SATA) and a personal computer interface (PCI) or any combination thereof.

3. The bridge according to claim 1, wherein the storage device comprises at least one of a flash memory, an optical disc driver (ODD) and a hard disc driver (HDD) or any combination thereof.

4. A data compressing method used in a bridge, comprising:
receiving a first data;
compressing the first data by undistorted compression for producing a second data;
temporarily storing the second data;
decompressing the temporarily stored second data for producing a third data; and
providing the third data.

5. A computer system, comprising:
an external host;
an external storage device; and
a bridge coupled between the external host and the external storage device for receiving a first data transmitted from the external host, compressing the first data by undistorted compression for producing a second data, temporarily storing the second data, and further decompressing the temporarily stored second data for producing a third data, wherein the third data and the first data are substantially the same, and the third data is outputted to the external storage device.

6. The computer system according to claim 5, wherein the bridge comprises:
a first interface coupled to the external host for receiving the first data transmitted from the external host.

7. The computer system according to claim 6, wherein the bridge further comprises:
an encoder coupled to the first interface for compressing the first data by undistorted compression for producing the second data.

8. The computer system according to claim 7, wherein the bridge further comprises:
a memory device coupled to the encoder for temporally storing the second data produced by the encoder.

9. The computer system according to claim 8, wherein the bridge further comprises:
a decoder coupled to the memory device for decompressing the second data stored in the memory device for producing the third data, wherein the third data and the first data are substantially the same.

10. The computer system according to claim 9, wherein the bridge further comprises:
a second interface coupled between the decoder and the external storage device for outputting the third data transmitted from the decoder to the external storage device.
